(19) United States
(12) Patent Application Publication
(10) Pub. No.: US 2012/0019630 A1
(43) Pub. Date: Jan. 26, 2012

(54) IMAGE OUTPUT APPARATUS AND IMAGE OUTPUT METHOD

(75) Inventor: Joji YAMASHITA, Fukaya-shi (JP)

(73) Assignee: KABUSHIKI KAISHA TOSHIBA, Tokyo (JP)

(21) Appl. No.: 13/169,496

(22) Filed: Jun. 27, 2011

(30) Foreign Application Priority Data
Jul. 22, 2010 (JP) 2010-165286

(51) Int. Cl. H04N 13/04

(52) U.S. Cl. 348/51; 348/E13.075

(57) ABSTRACT

According to one embodiment, an image output apparatus includes a counter and an output module. The counter is configured to count a 3D image output time. The output module is configured to output a 3D image and 3D image output time information used to provide notification of the 3D image output time.

### CROSS-REFERENCE TO RELATED APPLICATIONS

This application is based upon and claims the benefit of priority from Japanese Patent Application No. 2010-165286, filed Jul. 22, 2010, the entire contents of which are incorporated herein by reference.

### FIELD

Embodiments described herein relate generally to an image output apparatus and an image output method.

### BACKGROUND

Various techniques for displaying three- dimensional (3D) images have hitherto been disclosed and put to practical use. However, 3D televisions have not become so common because 3D images have lower brightness and resolution than two-dimensional (2D) images.

However, in recent years, large-capacity optical disks such as Blu-ray Disks (BDs) (registered trademark) and full-HD televisions have prevailed to enable high-quality 3D images to be reproduced in a frame sequential manner or the like. Thus, 3D televisions are expected to grow dramatically popular in the future.

Compared with 2D images, 3D images are known to fatigue viewers' eyes. Furthermore, 3D images are known to be likely to affect development of children's visual function.

However, techniques for preventing these adverse effects of 3D images are insufficient.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing an example of the configuration of a digital television broadcast receiving apparatus (image output apparatus) according to a first embodiment to a third embodiment;

FIG. 2 is a flowchart illustrating an example of a process of setting a 3D image output time;

FIG. 3 is a flowchart illustrating an example of a process of notifying a user of the 3D image output time;

FIG. 4 is a diagram showing an example of a setting menu screen;

FIG. 5 is a diagram showing an example of a 3D image output setting screen;

FIG. 6 is a diagram showing an example of a guidance screen (warning screen); and

FIG. 7 is a diagram illustrating a method for counting the 3D image output time.

### DETAILED DESCRIPTION

Various embodiments will be described hereinafter with reference to the accompanying drawings.

In general, according to one embodiment, an image output apparatus includes a counter and an output module. The counter is configured to count a 3D image output time. The output module is configured to output a 3D image and 3D image output time information used to provide notification of the 3D image output time.

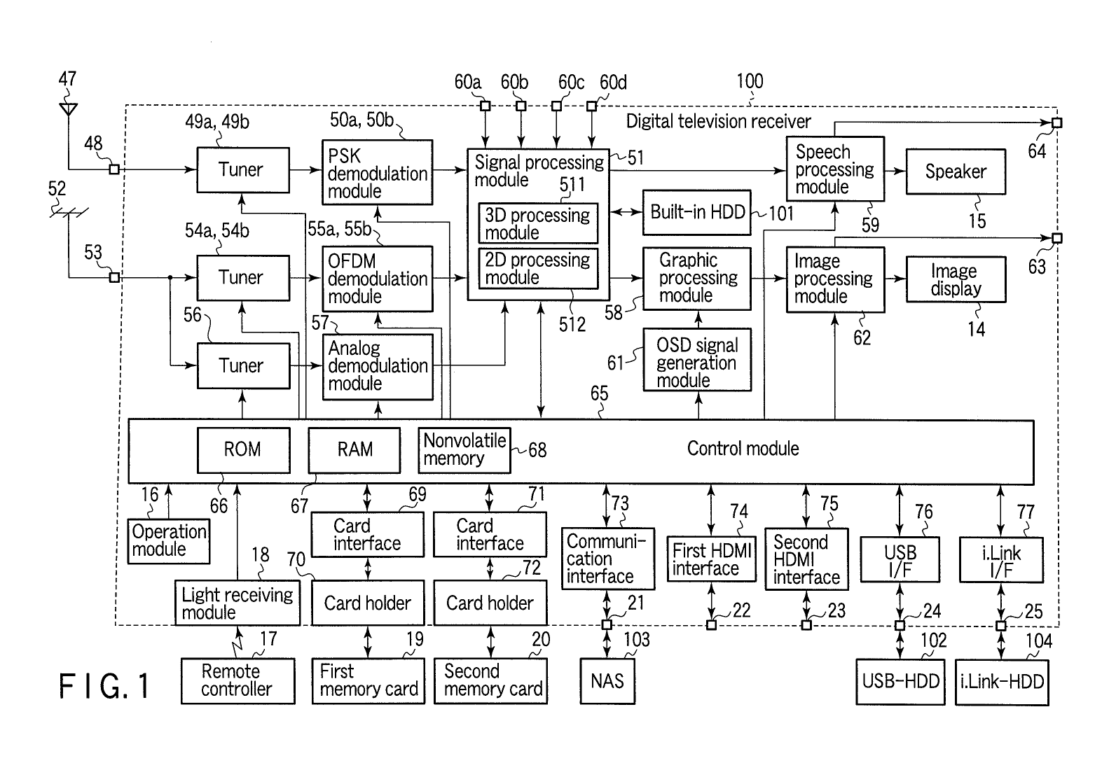

FIG. 1 is a digital television receiving apparatus (image output apparatus) according to the first to third embodiments. In the first to third embodiments, image output (control) performed by the digital television broadcast receiving apparatus is described. However, the present invention is not limited to the image output (control) performed by the digital television broadcast receiving apparatus. The image output (control) described below can be implemented by any program recording apparatus, for example, an HDD recorder, a Blu-ray Disk (BD) (registered trademark) recorder, or a DVD recorder.

With reference to FIG. 1, a digital television broadcast receiving apparatus 100 will be described. As shown in FIG. 1, a satellite digital television broadcasting signal received by an antenna 47 for reception of BS/CS digital broadcasting is supplied to satellite digital broadcasting tuners 49a and 49b via an input terminal 48. The tuners 49a and 49b select the broadcasting signal of a specified channel. The satellite digital broadcasting tuners 49a and 49b provided in the digital television broadcast receiving apparatus 100 allow satellite digital broadcasting signals of up to two channels to be simultaneously selected. As shown in FIG. 1, in a case described below, the digital television broadcast receiving apparatus 100 comprises the two satellite digital broadcasting tuners. However, the digital television broadcast receiving apparatus 100 may comprise three or more satellite digital broadcasting tuners.

The broadcasting signal selected by the tuners 49a and 49b is supplied to phase-shift keying (PSK) demodulation modules 50a and 50b. The PSK demodulation modules 50a and 50b demodulate the broadcasting signal and then output the demodulated signal to a signal processing module 51.

Furthermore, a terrestrial digital television broadcasting signal received by an antenna 52 for reception of terrestrial broadcasting is supplied to terrestrial digital broadcasting tuners 54a and 54b via an input terminal 53. The tuners 54a and 54b select the broadcasting signal of a specified channel. The terrestrial digital broadcasting tuners 54a and 54b provided in the digital television broadcast receiving apparatus 100 allow terrestrial digital broadcasting signals of up to two channels to be simultaneously selected. As shown in FIG. 1, in the case described below, the digital television broadcast receiving apparatus 100 comprises the two terrestrial digital broadcasting tuners. However, the digital television broadcast receiving apparatus 100 may comprise three or more terrestrial digital broadcasting tuners.

The broadcasting signal selected by the tuners 54a and 54b is supplied to an orthogonal frequency division multiplexing (OFDM) demodulation module 55. The OFDM demodulation module 55 demodulates the broadcasting signal into a digital image signal and a digital speech signal and outputs the image and speech signals to the signal processing module 51.

Furthermore, a terrestrial analog television broadcasting signal received by the antenna 52 for reception of terrestrial broadcasting is supplied to a terrestrial analog broadcasting tuner 56 via the input terminal 53. The tuner 56 selects the broadcasting signal of a specified channel. The broadcasting signal selected by the tuner 56 is supplied to an analog demodulation module 57. The analog demodulation module 57 demodulates the broadcasting signal into an analog image signal and an analog speech signal and outputs the image and speech signals to the signal processing module 51.

Here, the signal processing module 51 selectively carries out predetermined digital signal processing on the digital image and speech signals supplied by each of the PSK demodulation module 50 and OFDM demodulation module 55. The signal processing module 51 then outputs the processed image and speech signals to a graphic processing module 58 and a speech processing module 59.

Furthermore, a plurality of (in the illustrated apparatus, four) input terminals 60a, 60b, 60c, and 60d are connected to the signal processing module 51. Each of the input terminals 60a to 60d enables analog image and speech signals from an external source to be input to the digital television broadcast receiving apparatus 100.

The signal processing module 51 selectively digitalizes the analog image and speech signals fed from the analog demodulation module 57 and the input terminals 60a to 60d. The signal processing module 51 then carries out predetermined signal processing on the digitalized image and speech signals. The signal processing module 51 then outputs the processed signals to the graphic processing module 58 and the speech processing module 59.

The graphic processing module 58 provides a function to superimpose an OSD signal generated by an on-screen display (OSD) signal generation module 61 on the digital image signal supplied by the signal processing module 51 and then output the resultant signal. The graphic processing module 58 can selectively output the image signal output by the signal processing module 51 and the OSD signal output by the OSD signal generation module 61 or can combine the output image signal with the output OSD signal for output.

The digital image signal output by the graphic processing module 58 is supplied to an image processing module 62. The image signal processed by the image processing module 62 is supplied to an image display 14 and to an output terminal 63. The image display 14 displays an image based on the image signal. When an external apparatus is connected to the output terminal 63, an image signal supplied to the output terminal is input to the external apparatus.

Furthermore, the speech processing module 59 converts the input digital speech signal into an analog speech signal that can be reproduced by the speaker 15. The speech processing module 59 outputs the analog speech signal to the speaker 15 for speech output and also allows the analog speech signal to be transmitted to an external apparatus via an output terminal 64.

A control module 65 of the digital television broadcast receiving apparatus 100 integrally controls all processes and operations including the above-described signal processing. The control module 65 comprises a central processing unit (CPU). Based on operation information from an operation section 16 or operation information transmitted by the remote controller 17 and received via a light receiving section, the control module 65 controls the other modules so as to reflect the contents of the operation in processes carried out by the other modules.

In this case, the control module 65 mainly utilizes a read-only memory (ROM) 66 in which control programs executed by the CPU, random access memory (RAM) 67 configured to provide a work area for the CPU, and a nonvolatile memory 68 in which various pieces of setting information, control information, and the like are stored.

Furthermore, the control module 65 is connected, via a card interface 69, to a card holder 70 in which a first memory card 19 can be installed. Thus, the control module 65 can transmit information via the first memory card 19 installed in the card holder 70 and via the card interface 69.

Additionally, the control module 65 is connected, via a card interface 71, to a card holder 72 in which a second memory card 20 can be installed. Thus, the control module 65 can transmit information via the second memory card 20 installed in the card holder 72 and via the card interface 71.

In addition, the control module 65 is connected to a LAN terminal 21 via a communication interface 73. Thus, the control module 65 can transmit information, via a communication interface 73, to a LAN-compatible apparatus connected to the LAN terminal 21. In this case, the control module 65 provides a Dynamic Host Configuration Protocol (DHCP) server function to control the LAN-compatible apparatus connected to the LAN terminal 21 by assigning an Internet Protocol (IP) address to the LAN-compatible apparatus. An example of the LAN-compatible apparatus is network-attached storage (NAS) 103.

Moreover, the control module 65 is connected to a first HDMI terminal 22 via a first HDMI interface 74. Thus, the control module 65 can transmit information, via the first HDMI interface 74, to an HDMI-compatible apparatus connected to the first HDMI terminal 22. Furthermore, the control module 65 is connected to a second HDMI terminal 23 via a second HDMI interface 75. Thus, the control module 65 can transmit information, via the second HDMI interface 75, to an HDMI-compatible apparatus connected to the second HDMI terminal 23.

The control module 65 is connected to the USB terminal 24 via a USB interface 76. Thus, the control module 65 can transmit information, via the USB interface 76, a USB-compatible apparatus connected to the USB terminal 24. An example of the USB-compatible apparatus is a USB-HDD 102.

Moreover, the control module 65 is connected to an i.Link terminal 25 via an i.Link interface 77. Thus, the control module 65 can transmit information, via the i.Link interface 77, an i.Link-compatible apparatus connected to the i.Link terminal 25. An example of the i.Link-compatible apparatus is an i.Link-HDD 104.

Furthermore, the control module 65 references programmed recording information contained in a programmed recording list stored in a nonvolatile memory 68 to control programmed recording operations. Programs are recorded in, for example, a built-in HDD 101, USB-HDD 102, NAS 103, and i.LINK-HDD 104.

Subsequently, 3D and 2D image outputs from the digital television broadcast receiving apparatus 100 will be described.

The signal processing module 51 of the digital television broadcast receiving apparatus 100 comprises a 3D processing module 511. The digital television broadcast receiving apparatus 100 is configured to be able to provide 3D images via a 3D processing module 511.

For example, the digital television broadcast receiving apparatus 100 displays 3D images using a time division system. The time division system allows 3D images to be displayed or viewed using a combination of a high-speed driving display and a pair of active liquid crystal shutter eyeglasses.

That is, the digital television broadcast receiving apparatus 100 can display 3D images corresponding to the time division system. That is, the 3D processing module 511 switches, for each frame, between a right-eye image and a left-eye image both contained in a 3D image signal, and then outputs the resultant image. In response, the image display 14 (high-speed driving display) switches the right-eye image and the left-eye image for each frame and then displays the resultant image.

A user can view 3D images with a pair of active liquid crystal shutter glasses. That is, the pair of liquid crystal shutter glasses alternately closes a right-eye shutter and a left-eye shutter in response to the switching between the right-eye image and the left-eye image for each frame. Thus, the right eye views the right-eye image, whereas the left eye views the left-eye image.

An example of 3D image display based on the time division system has been described above. However, other 3D display systems are also applicable. For example, a 3D image display system allowing the user to view 3D images with the naked eye can also be applied.

Furthermore, the 3D processing module 511 carries out a 3D conversion process of converting a 2D image signal into a 3D image signal to provide a 3D image based on the 2D image signal.

Moreover, the signal processing module 51 of the digital television broadcast receiving apparatus 100 comprises a 2D processing module 512. The digital television broadcast receiving apparatus 100 is configured to be able to provide 2D images via a 2D processing module 512. For example, the 2D processing module 512 carries out a 2D conversion process of converting a 3D image signal into a 2D image signal to provide 2D images based on the 3D image signal.

As described above, the digital television broadcast receiving apparatus 100 can provide 3D images based on a 3D image signal, provide 2D images based on a 3D image signal, provide 2D images based on a 3D image signal, and provide 2D images based on a 2D image signal.

A 2D conversion process and a 3D conversion process disclosed in, for example, Jpn. Pat. Appln. KOKAI Publication No. 2006-121553 can be applied to the 3D conversion process in the 3D processing module 511 and the 2D conversion process in the 2D processing module 51, respectively.

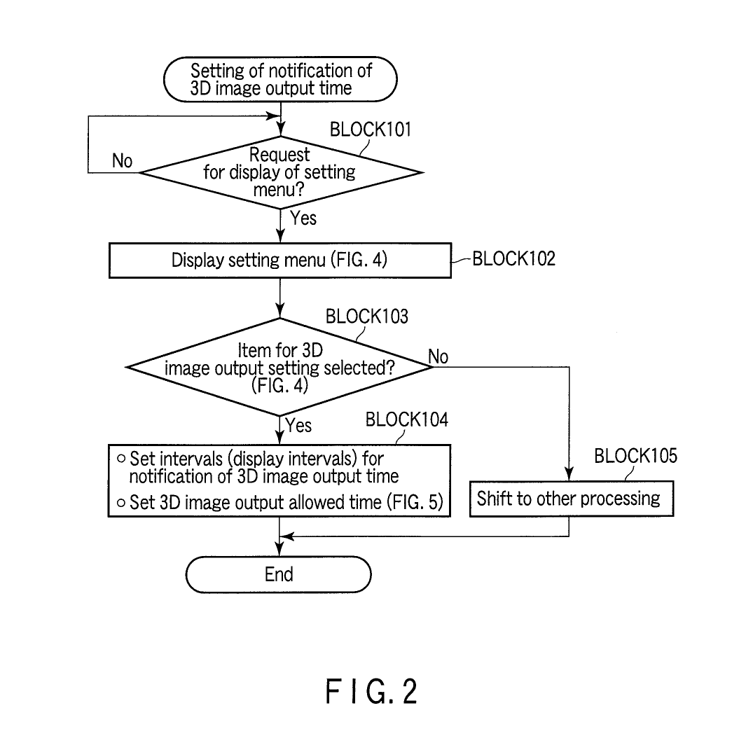

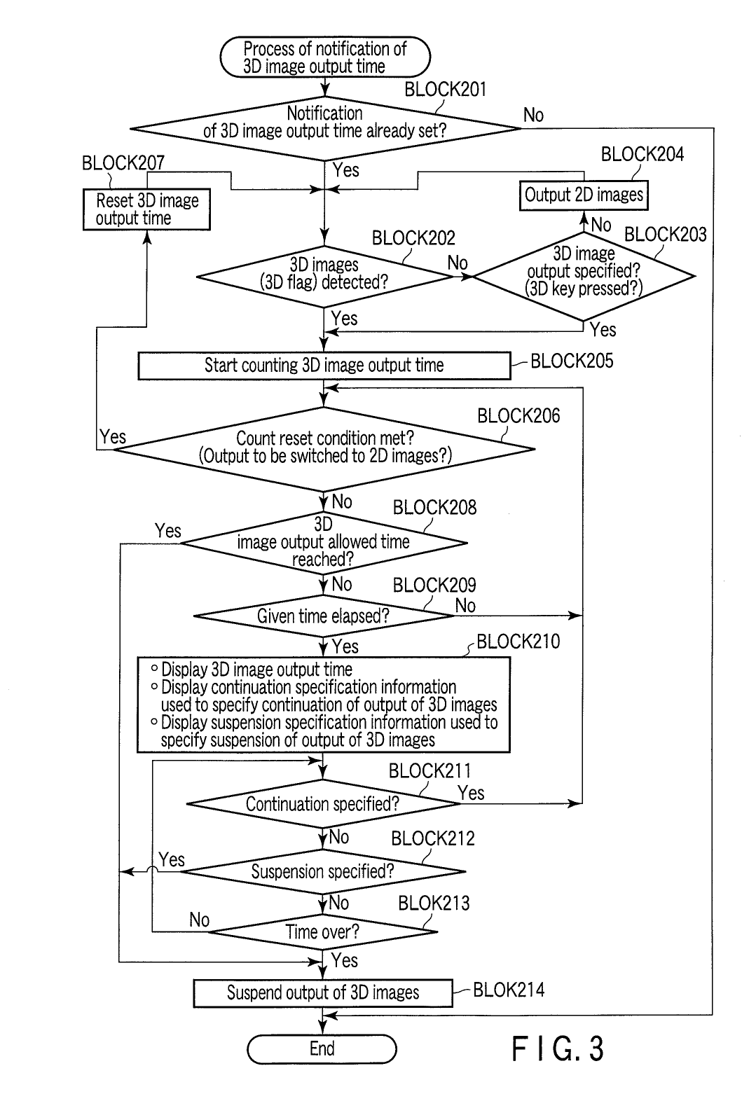

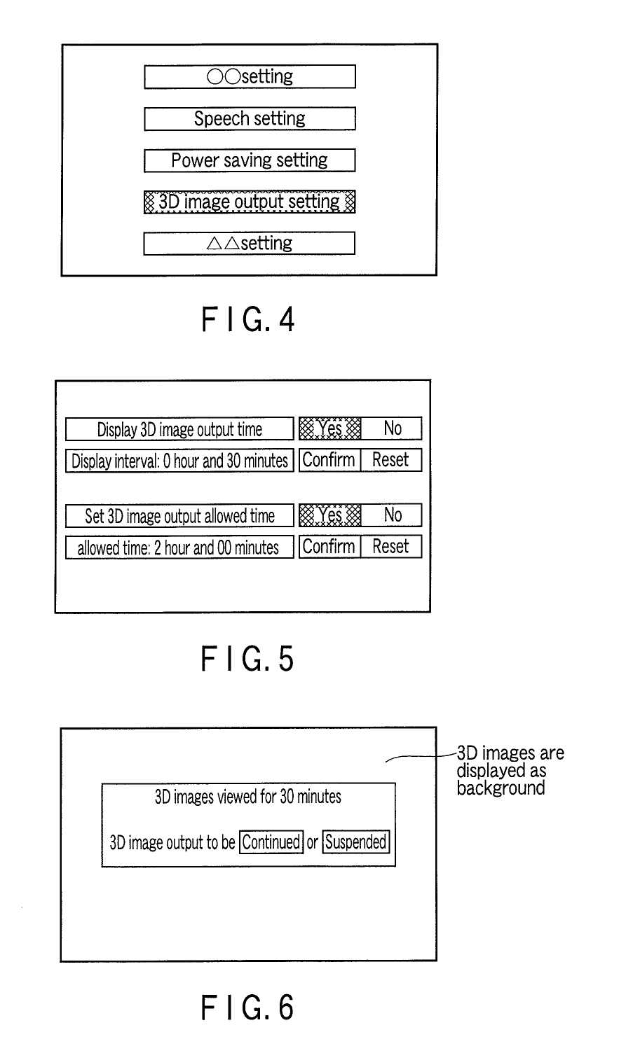

Now, with reference to the flowchart shown in FIGS. 2 and 3 and a display example of a screen shown in FIG. 4 to FIG. 6, an example of image output (control) will be described.

### First Embodiment

The control module 65 of the digital television broadcast receiving apparatus 100 controls the output of 3D images, counts a 3D image output time, and controllably allows 3D image output time information to be output which is used to notify the user of the 3D image output time. In response, the image processing module 62 outputs 3D images and 3D image output time information. For example, the control module 62 controllably allows the 3D image output time information to be output at intervals of predetermined output time (for example, every 30 minutes of 3D image output). In response, the image processing module 62 outputs the 3D image output time information at intervals of predetermined output time (for example, every 30 minutes of 3D image output).

For example, if the user specifies a predetermined channel (3D image program) via the remote controller 17 or the like, the tuner 54a and the like selects one of the broadcasting signals which belongs to the predetermined channel. In response, the control module 65 controllably allows 3D images in the signal of the predetermined channel to be output. The control module 65 further counts the 3D image output time and controllably allows the 3D output time information to be output at intervals of a predetermined 3D image output time (for example, every 30 minutes of 3D image output). In response, the image processing module 62 outputs 3D images of the signal of the predetermined channel. The image processing module 62 further outputs the 3D image output time information at intervals of a predetermined output time (for example, every 30 minutes of 3D image output). Thus, the image display 14 displays 3D images and also displays the 3D image output time information at intervals of a predetermined output time. For example, every time 3D images are output for 30 minutes, the image display 14 displays the message “3D images viewed for 30 minutes. 3D image viewing to be continued? YES/NO”.

The user can select YES via the remote controller 17 or the like. In response to the selection of YES, the control module 65 continues to control the output of 3D images and to count the 3D image output time. Furthermore, the user can select NO via the remote controller 17 or the like. In response to the selection of NO, the control module 65 stops outputting 3D images and resets the count of the 3D image output time.

A process of notifying the user of the 3D image output time will be described below in detail.

First, with reference to FIG. 2, an example of a process of setting the 3D image output time will be described.

The user can specify display of a setting menu, for example, via a setting menu provided on the remote controller 17. The remote controller 17 requests display of the setting menu in response to pressing of the setting menu key (BLOCK 101, YES). The control module 65 receives the request for the display of the setting menu via the light receiving module 18 to control the display of the setting menu. In response, the image display 14 displays such a setting menu as shown in FIG. 4 (BLOCK 102).

Subsequently, the user can select an item for 3D image output setting displayed on the setting menu, via direction keys and an Enter key provided on the remote controller 17. The remote controller 17 requests item selection for 3D image output setting in response to pressing of the direction keys and Enter key (BLOCK 103, YES). The control module 65 receives the request for the item selection for 3D image output setting via the light receiving module 18 to control the display of a 3D image output setting screen. In response, the image display 14 displays such a 3D image output setting screen as shown in FIG. 5.

For example, as shown in FIG. 5, the 3D image output setting screen displays “3D image output time to be displayed? YES/NO”. The user selects YES displayed on the 3D image output setting menu, via the direction keys and Enter key provided on the remote controller 17. Then, the control module 65 detects the selection of “YES” and requests the user to input a display interval for the 3D image output time. This enables the display interval for the 3D image output time to be input onto the 3D image output setting screen.

The user inputs the display interval for the 3D image output time (for example, 30 minutes) via the numeric keys and Enter key provided on the remote controller 17, and then selects “Confirm”. Then, the control module 65 sets the display interval for the 3D image output time (BLOCK 104). For example, the display interval for the 3D image output time is stored in the nonvolatile memory 68.

Moreover, as shown in FIG. 5, “3D image output allowed time to be set, YES/NO” may be displayed on the 3D image output setting screen. The user selects YES displayed on the 3D image output setting menu, via the direction keys and Enter key provided on the remote controller 17. Then, the control module 65 detects the selection of “YES” and requests the user to input a 3D image output allowed time. This enables the 3D image output allowed time to be input onto the 3D image output setting screen.

The user inputs the 3D image output allowed time (for example, 2 hours and 00 minutes) via the numeric keys and Enter key provided on the remote controller 17, and then selects “Confirm”. Then, the control module 65 sets the 3D image output allowed time (BLOCK 104). For example, the 3D image output allowed time is stored in the nonvolatile memory 68.

Now, an example of a process for notifying the user of the 3D image output time will be described with reference to FIG. 3.

With the setting of notification of the 3D image output time completed as described above (BLOCK 201, YES), the signal processing module 51 detects, in an input signal, 3D information (3D flag) indicating that the input signal contains 3D images (BLOCK 202, YES). The control module 65 controllably allows 3D images to be output and starts counting the 3D image output time (BLOCK 205). In response, the image processing module 62 outputs 3D images, and the image display 14 displays the 3D images.

Even if the signal processing module 51 fails to detect the 3D information in the input signal, the signal processing module 51 can analyze the input signal to determine whether or not the input signal contains 3D images. For example, as described above, a 3G image signal comprises a right-eye image signal and a left-eye image signal. The signal processing module 51 can detect a thus configured image signal in the input signal to determine whether or not the input signal corresponds to a 3D image signal. Upon determining that the input signal corresponds to a 3D image signal, the signal processing module 51 controllably allows 3D images to be output and starts counting the 3D image output time (BLOCK 205).

In another case, with the setting of notification of the 3D image output time completed (BLOCK 201, YES), the remote controller 17 requests output of 3D images in response to pressing of a 3D key provided on the remote controller 17 (BLOCK 203, YES). Then, the controller 65 detects the request for output of 3D images, controllably allows 3D images to be output, and starts counting the 3D image output time (BLOCK 205).

If the 3D information (3D flag) is not detected (BLOCK 202, NO) and the output of 3D images is not requested (BLOCK 203, NO), then for example, the image display 14 displays 2D images (BLOCK 204).

Counting of the 3D image output time is started (BLOCK 205). The control module 65 determines that a count reset condition for the 3D image output time is not met (BLOCK 206, YES) and that the 3D image output time has not become equal to the 3D image output allowed time (already set in BLOCK 104) (BLOCK 208, YES). Then, the control module 65 continues to count the 3D image output time.

The count reset condition is as follows. For example, the control module 65 can detect switching from the 3D image output to the 2D image output. Thus, upon detecting switching from the 3D image output to the 2D image output (BLOCK 206, YES), the control module 65 resets the count of the 3D image output time (BLOCK 207).

Upon detecting that the 3D image output time has become equal to the 3D image output allowed time (BLOCK 208, NO), the control module 65 controllably allows the output of 3D images to be suspended (BLOCK 214). The control module 65 then resets the count of the 3D image output time.

Upon detecting elapse of a given time (corresponding to the display interval set in BLOCK 104) from the start of output of 3D images (BLOCK209, YES), the control module 65 controllably allows such a guidance screen (warning screen) as shown in FIG. 6 to be output. In response, the image processing module 62 outputs the guidance screen (warning screen), and the image display 14 displays such a guidance screen as shown in FIG. 6. As shown in FIG. 6, the guidance screen displays, for example, the information “3D images viewed for 30 minutes. 3D image output to be continued or suspended.”

When the user selects “Continued” via the direction keys and Enter key provided on the remote controller 17 (BLOCK 211, YES), the control module 65 continues to control the output of 3D images and to count the 3D image output time. In response, the image processing time 62 continues to output 3D images. Thereafter, the process continues to BLOCK 206 and the subsequent blocks.

When the user selects “Suspended” via the direction keys and Enter key provided on the remote controller 17 (BLOCK 212, YES), the control module 65 controllably allows the output of 3D images to be suspended. The image processing module 62 suspends the output of 3D images (BLOCK 214). In this case, the control module, for example, resets the count of the 3D image output time.

When neither “Continued” nor “Suspended” is selected and the control module 65 detects that the time for the item selection is over (BLOCK 213, YES), the control module 65 controllably allows the output of 3D images to be suspended. The image processing module 62 suspends the output of 3D images (BLOCK 214). In this case, the control module 65, for example, resets the count of the 3D image output time.

In the above-described case, the 3D image output time information is output (displayed) at intervals of the given time (at intervals of the predetermined output time for 3D images). However, the 3D image output time information may be constantly output (displayed).

### Second Embodiment

In the case described above in the first embodiment, only the 3D image output period is counted as 3D image output time. However, the 3D image output time is counted by a count method illustrated below.

### First Count Method

Even if a 2D image output period is present after 3D images have been output, the control module 65 also counts the 2D image output period as a part of the 3D image output time.

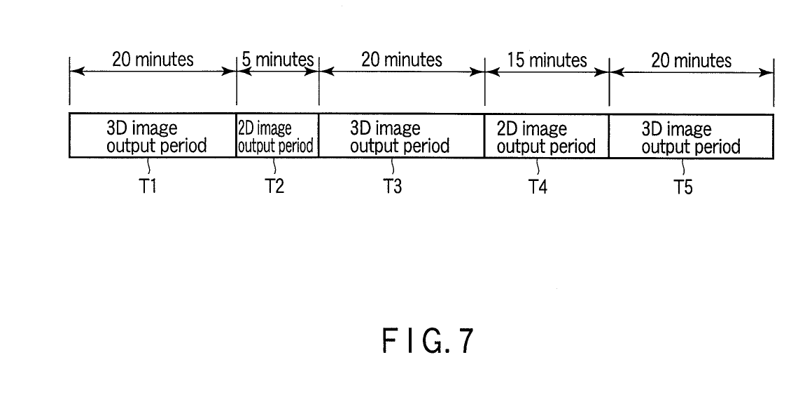

With reference to FIG. 7, an example of the first count method will be described. For example, it is assumed that 2D images and 3D images have been output in order of a 3D image output period T1 (20 minutes), a 2D image output period T2 (5 minutes), a 3D image output period T3 (20 minutes), a 2D image output period T4 (15 minutes), and a 3D image output period T5 (20 minutes), as shown in FIG. 7.

In the case shown in FIG. 7, the control module 65 also counts the 2D image output period as a part of the 3d image output time. Hence, the control module 65 accumulates the 3D image output period T1 (20 minutes), the 2D image output period T2 (5 minutes), the 3D image output period T3 (20 minutes), the 2D image output period T4 (15 minutes), and the 3D image output period T5 (20 minutes) to calculate the 3D image output time (20 minutes+5 minutes+20 minutes+15 minutes+20 minutes=80 minutes).

### Second Count Method

If a 2D image output period is present after 3D images have been output and is shorter than an intermission determination time, the control module 65 counts the 2D image output period as a part of the 3D image output time. However, if the 2D image output period is equal to or longer than the intermission determination time, the control module 65 avoids counting the 2D image output period as a part of the 3D image output time.

With reference to FIG. 7, an example of a second count method will be described. It is assumed that an intermission determination time of 10 minutes is stored in the nonvolatile memory 68.

In the case shown in FIG. 7, the control module 65 counts the 2D image output period T2 (5 minutes), which is shorter than the intermission determination time of 10 minutes, as a part of the 3D image output time. Furthermore, the control module 65 avoids counting the 2D image output time T4 (15 minutes), which is equal to or longer than the intermission determination time of 10 minutes, as a part of the 3D image output time.

Hence, the control module 65 accumulates the 3D image output period T1 (20 minutes), the 2D image output period T2 (5 minutes), the 3D image output period T3 (20 minutes), and the 3D image output period T5 (20 minutes) to calculate the 3D image output time (20 minutes+5 minutes+20 minutes+20 minutes=65 minutes).

### Third Embodiment

In the case described in the first embodiment, the count of the 3D image output time is reset if a 2D image is output after 3D images have been output. However, the count of the 3D image output time may be reset by a reset method illustrated below.

### First Reset Method

The control module 65 resets the count of the 3D image output time based on detection of a power-off operation.

### Second Reset Method

Upon detecting that 24 hours (one day) have elapsed since the start of counting of the 3D image output time, the control module 65 resets the count of the 3D image output time.

### Third Reset Method

Upon detecting that the input has been switched, the control module 65 resets the count of the 3D image output time.

### Fourth Reset Method

Upon detecting that the channel has been switched, the control module 65 resets the count of the 3D image output time.

### Fifth Reset Method

Upon detecting that a selected program (3D image program) has ended, the control module 65 resets the count of the 3D image output time.

### Sixth Reset Method

When the user instructs the apparatus to reset the count of the 3D image time via the remote controller or the like, the control module 65 in response resets the count of the 3D image output time.

As illustrated in the first, second, and third embodiments, the digital television broadcast receiving apparatus 100 can display the 3D image output time in association with the output of 3D images. Furthermore, the digital television broadcast receiving apparatus 100 can not only display the 3D image output time but also ask the user whether or not to continue to view 3D images. Moreover, if the user fails to perform an input operation in response to the inquiry whether or not to continue to view 3D images, the digital television broadcast receiving apparatus 100 can suspend or stop the output of 3D images. Thus, children with the visual function still developing can be prevented from continuing to view 3D images without permission. Furthermore, the user can be prevented from being absorbed in 3D image games or movies to view 3D images for a long time.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image output apparatus comprising:
a counter configured to count a 3D image output time; and
an output module configured to output a 3D image and 3D image output time information for providing notification of the 3D image output time.

2. The apparatus of claim 1, wherein the output module is configured to output the 3D image output time information at an interval.

3. The apparatus of claim 1, wherein the output module is configured to output
continuation specification information used to specify continuation of output of the 3D image, and
suspension specification information used to specify suspension of output of the 3D image.

4. The apparatus of claim 2, wherein the output module is configured to output, at the interval,
continuation specification information used to specify continuation of output of the 3D image, and
suspension specification information used to specify suspension of output of the 3D image.

5. The apparatus of claim 2, further comprising:
a setting module configured to set the interval.

6. The apparatus of claim 4, wherein the output module is configured to continue to output the 3D image when the continuation specification information is selected and is configured to suspend the output of the 3D image when the suspension specification information is selected.

7. The apparatus of claim 6, wherein the output module is configured to suspend the output of the 3D image if the continuation specification information or the suspension specification information fails to be selected within a limit time.

8. The apparatus of claim 1, wherein the output module is configured to compare the 3D image output time with a 3D image output allowed time and to suspend the output of the 3D image based on a result of the comparison.

9. The apparatus of claim 1, wherein the counter is configured to count a total time of the 3D image output time and a 2D image output time following the output of the 3D image, as the 3D image output time.

10. The apparatus of claim 1, wherein the counter is configured to count a total time of a first output period of the 3D image, a second output period of the 3D image, and a third output period of a 2D image between the first output period of the 3D image and the second output period of the 3D image, as the 3D image output time when the third output period of the 2D image is shorter than an intermission determination reference time, and to count a total time of the first and second output periods as the 3D image output time when the third output period is equal to or longer than the intermission determination reference time.

11. The apparatus of claim 1, wherein the counter is configured to reset the 3D image output time based on a channel switching operation.

12. An image output method comprising:
outputting a 3D image;
counting a 3D image output time; and
outputting 3D image output time information for providing notification of the 3D image output time.

13. The apparatus of claim 12, wherein outputting the 3D image output time information comprises outputting the 3D image output time information at an interval.
